(19) United States
(12) Patent Application Publication
(10) Pub. No.: US 2005/0057651 A1
(43) Pub. Date: Mar. 17, 2005

(54) Apparatus for visually confirming vehicle periphery

(75) Inventors: Masayoshi Imoto, Mie (JP); Kenichi Ohue, Aichi (JP); Hideyuki Ide, Aichi (JP); Yasuhiko Yamamoto, Aichi (JP); Naoki Sagara, Aichi (JP); Hideya Hori, Aichi (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP); TOYOTA AUTO BODY CO., LTD., Kariya-shi (JP); AISIN SEIKI KABUSHIKI KAISHA, Kariya-shi (JP)

(21) Appl. No.: 10/901,354

(22) Filed: Jul. 29, 2004

(30) Foreign Application Priority Data
Aug. 1, 2003 (JP) P2003-284841

(51) Int. Cl. H04N 7/18

(52) U.S. Cl. 348/148; 348/143

(57) ABSTRACT

An apparatus for visually confirming a vehicle periphery includes a camera device which is attached to a vehicle, and which picks up a image in at least one direction at the vehicle periphery and a display unit which displays the picked-up image in the at least one direction on a display unit installed in the vehicle. The camera device is attached to the vehicle while a position of the camera device is inclined, so that a vehicle is at least partially taken in the picked-image in the at least one direction, The image-processing device carries out a rotation process with respect to the picked-up image, in which a scene taken in the picked-up image is inclined due to an inclination resulting from the position of the camera device, so that an inclination of the scene is negated, and which displays the scene in the display unit.

### BACKGROUND OF THE INVENTION

1. Field of the Invention

The present invention relates to an apparatus for visually confirming a vehicle periphery, which picks up the scenes in a plurality of directions at the periphery of a vehicle by a single camera device installed in the vehicle and displays the picked-up images in the respective picking-up directions on a display unit installed in the vehicle.

2. Description of the Related Art

As this type of apparatus for visually confirming a vehicle periphery in a related art, such a type has been publicly known, which picks up images in three directions including, for example, a forward diagonally downward direction and both forward left and right side directions by a single camera installed at, for example, the front part of a vehicle, and displays images picked up in the respective picking-up directions in a display unit installed in the vehicle. In this type of apparatus for visually confirming a vehicle periphery, the camera device is installed in a vehicle so that only scenes in the picking-up directions are taken in images picked up in the respective picking-up directions and any part of the vehicle is not taken in the images, and the display unit displays the images picked up in the respective picking-up directions, in which only the scenes in the picking-up directions are taken in. (Please see JP-A-2000-89301.)

In conventional apparatus for visually confirming a vehicle periphery, since picked-up images in which only the scenes in the picking-up directions are taken and any part of the vehicle is not taken are displayed in the display unit, there is a problem in which it is difficult to understand the sense in directions, that is, in which direction of a vehicle a picked-up image displayed in the display unit is taken, and another problem in that it is difficult to understand a sense in distance between an obstacle picked up in the image and the vehicle.

Therefore, such a plan has been proposed, in which a camera device is attached to a vehicle so that the position thereof is inclined downward (that is, so as to further incline the picking-up direction of the forward diagonally downward direction), for example, so that a part of the vehicle such as the front bumper, front grille, etc., is taken in a picked-up image in the forward diagonally downward direction.

However, if the position of the camera device is inclined downward, the visual field range of pick-up in both the forward left and right side directions of the inclined portion thereof (that is, the portion in which the picking-up direction of the forward diagonally downward direction is further inclined) is inclined around the picking-up direction. As a result, there is still another problem in that a scene taken in the picked-up image in both the forward left and right side directions, which is displayed in a display unit, is inclined to the inclination in the position of the camera device, and is taken in, wherein the visibility of the picked-up image in both the forward left and right side directions is worsened.

As a method for solving the problem, such a plan has been proposed, in which the inclination of a scene taken in the picked-up image in both the forward left and right side directions, which is displayed in the display unit, is corrected by correcting and altering the disposition angle of components (optical components and pick-up elements) in the camera device.

However, with the plan, since the degree of inclination with respect to the position of the camera device differs according to models of vehicles, it is necessary to make the disposition angles of the component elements different according to respective models of the vehicles per model, and to produce different types of camera devices model by model, wherein the camera device cannot be made common, and there is a shortcoming in that the production cost thereof is increased.

### SUMMARY OF THE INVENTION

It is an object of the present invention to provide an apparatus for visually confirming a vehicle periphery, for which a camera device is attached to a vehicle with the position thereof inclined so that a part of the vehicle can be taken in a picked-up image at least in one picking-up direction, the camera device can be made common for respective models of vehicles, and which is capable of correcting the inclination of a scene taken in a picked-up image, which results from inclination in the position of the camera device.

In order to solve the above-described problems, a first aspect of the invention provides an apparatus for visually confirming a vehicle periphery, which picks up the scenes in a plurality of directions at the periphery of a vehicle by a single camera device installed in the vehicle and displays the picked-up images in the respective picking-up directions on a display unit installed in the vehicle; wherein the above-described camera device is installed, with its position inclined, in a vehicle so that at least a part of the vehicle can be taken in a picked-up image at least in one picking-up direction of the picked-up images in the respective picking-up directions; and the above-described apparatus for visually confirming a vehicle periphery includes image-processing device which carries out a rotation process with respect to an image, in which a scene taken in the above-described picked-up image is inclined due to the above-described inclination resulting from the position of the above-described camera device, of the picked-up images in the above-described respective picking-up directions so that the inclination of the above-described scene is negated, and which displays the same in the above-described display unit.

A second aspect of the invention provides an apparatus for visually confirming a vehicle periphery, in which the above-described camera device is attached to the above-described vehicle by an attaching member in a state where the position thereof is inclined, and by replacement of the above-described attaching member in compliance with the above-described vehicle, the inclination in the position of the above-described camera device is adjusted in compliance with the above-described vehicle.

A third aspect of the invention provides an apparatus for visually confirming a vehicle periphery further comprising display-selecting device for selectively displaying a picked-up image at least in one direction of the picked-up images in the respective picking-up directions on the above-described display unit manually by prescribed switch operations or automatically on the basis of vehicle information of the above-described vehicle.

A fourth aspect of the invention provides an apparatus for visually confirming a vehicle periphery, in which the above-described camera device simultaneously picks up scenes in three directions including both forward left and right side directions and forward diagonally downward direction of the above-described vehicle, and is attached to the above-described vehicle, in a state where the position thereof is inclined, so that a part of the vehicle is taken in a picked-up image in the forward diagonally downward direction, and the above-described display unit simultaneously displays picked-up images in the three directions including both forward left and right side directions and forward diagonally downward direction, which are picked up by the above-described camera device.

According to the first aspect, since the camera device is attached, with the position thereof inclined, to a vehicle so that a part of the vehicle is taken in a picked-up image at least in one direction of picked-up images in the respective picking-up directions, it becomes possible to sensorially understand, on the basis of the part of the vehicle taken in the picked-up images, in which direction of the vehicle the picked-up image displayed in a display unit has been taken, and at the same time it becomes easier to understand the distance between an obstacle taken in the picked-up image and the vehicle.

Further, since the apparatus is provided with image processing device, the image processing device can rotate a picked-up image in the respective picking-up directions, wherein it is possible to negate the inclination of the scene taken in the picked-up image in the picking-up direction, which results from the inclination in the position of the camera device. Therefore, it is not necessary to produce a camera device while making the disposition angle of the component elements thereof (that is, optical system and pick-up elements, etc.) different model by model, wherein the camera device can be made common among various models of vehicles, and its visibility of a picked-up image can be comfortably improved in line with a decrease in production costs thereof.

According to the second aspect, since the camera device is attached to a vehicle by an attaching member with its position thereof inclined, and the attaching member can be replaced in compliance with vehicles, the inclination position of the camera device can be adjusted in compliance with a vehicle, and it is possible to adjust the inclination position of the camera only by replacing the attaching member, wherein the attaching member contributes to common use of a camera device among various models of vehicles.

According to the third aspect, since a picked-up image at least in one direction of the picked-up images in the respective picking-up directions can be selectively displayed in said display unit manually by prescribed switch operations or automatically on the basis of vehicle information of said vehicle, it is possible to selectively display only a picked-up image in a prescribed picking-up direction, and it is possible to selectively display only a picked-up image in an appropriate direction in compliance with a driving situation, wherein the degree of freedom can be increased with respect to the composition of the image display.

According to the fourth aspect, the above-described camera device simultaneously picks up scenes in three directions including both forward left and right side directions and forward diagonally downward direction of the above-described vehicle, and is attached to the above-described vehicle, in a state where the position thereof is inclined, so that a part of the vehicle is taken in a picked-up image in the forward diagonally downward direction, and the above-described display unit simultaneously displays picked-up images in the three directions including both forward left and right side directions and forward diagonally downward direction, which are picked up by the above-described camera device. Therefore, on the basis of a part of the vehicle, which is taken in the forward diagonally downward picked-up image portion, it is possible to sensorially understand that the picked-up images displayed in the display unit 5 are those obtained by picking up the scenes in the three directions including both forward left and right side directions of a vehicle and the forward diagonally downward direction thereof, and it becomes easier to understand the distance between an obstacle taken in the picked-up images and the vehicle.

### BRIEF DESCRIPTION OF THE DRAWINGS

These and other objects and advantages of this invention will become more fully apparent from the following detailed description taken with the accompanying drawings in which:

FIG. 1 is a general configurational view of an apparatus for visually confirming a vehicle periphery according to an embodiment of the invention;

FIG. 2 is a general configurational view of a camera device of FIG. 1 in its plan;

FIG. 3 is a cross-sectional view taken along the line III-III in FIG. 2;

FIGS. 4A and 4B are general views showing constrcution of a two-direction camera attached to a vehicle according to the invention in its plan view and its side view, respectively;

FIG. 5 is an exemplary side elevational view showing an attached state of a camera device in a vehicle in FIG. 1;

FIG. 6 is a view showing one example of an image picked up by a camera device;

FIG. 7 is a view showing one example of a case where picked-up images in three directions of the display image are displayed in the display unit in FIG. 1;

FIG. 8 is an exemplary side elevational view showing an attached state of a camera device in a vehicle in its horizontal position;

FIG. 9 is a view showing one example of picked-up images with the camera device attached;

FIG. 10 is a view showing one example of a case where picked-up images in two dimensions of the display image are displayed in the display unit in FIG. 1; and

FIG. 11 is a view showing one example of a case where picked-up images in one dimension of the display image are displayed in the display unit in FIG. 1.

### DESCRIPTION OF THE PREFERRED EMBODIMENTS

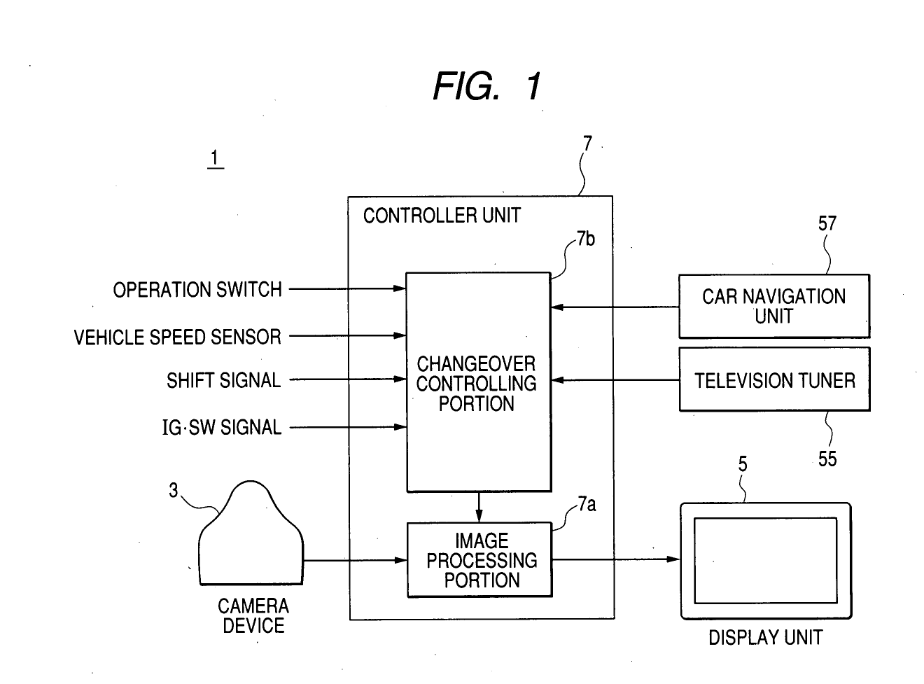

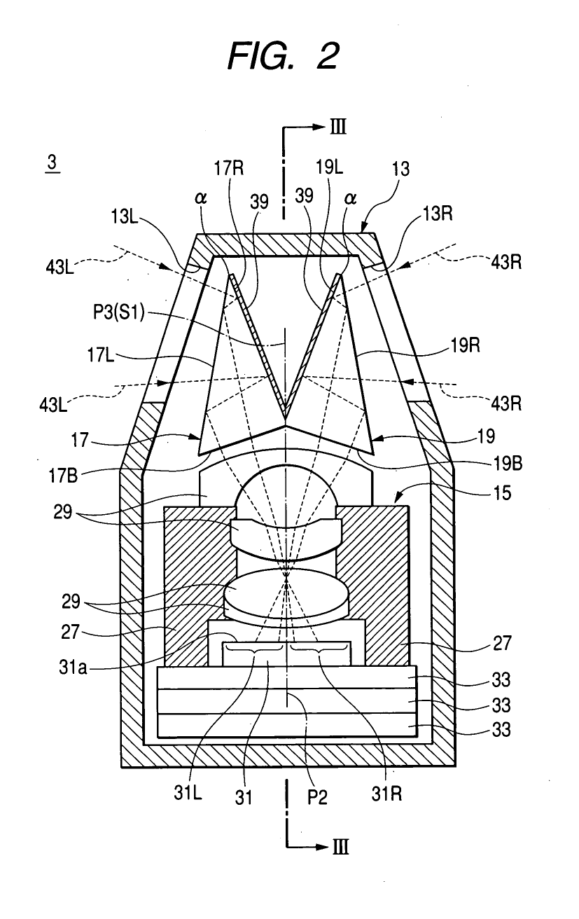

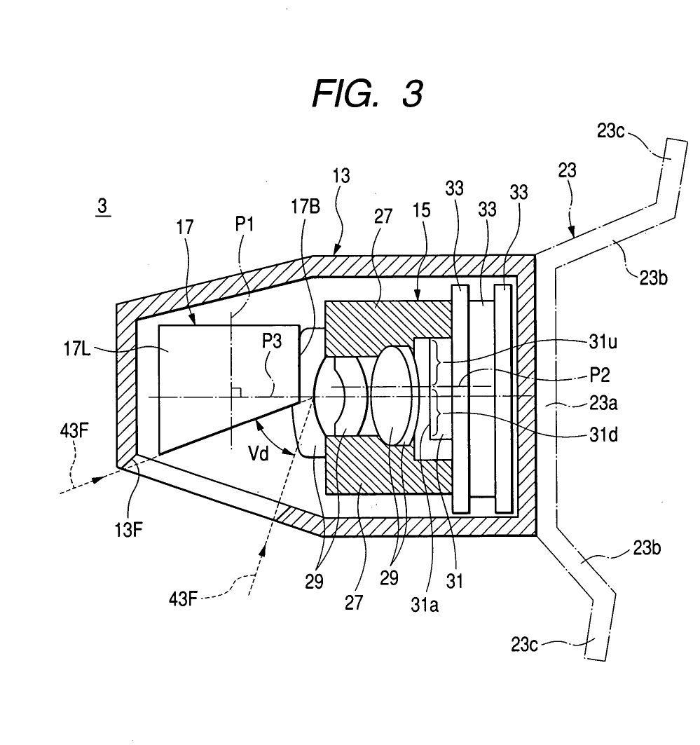

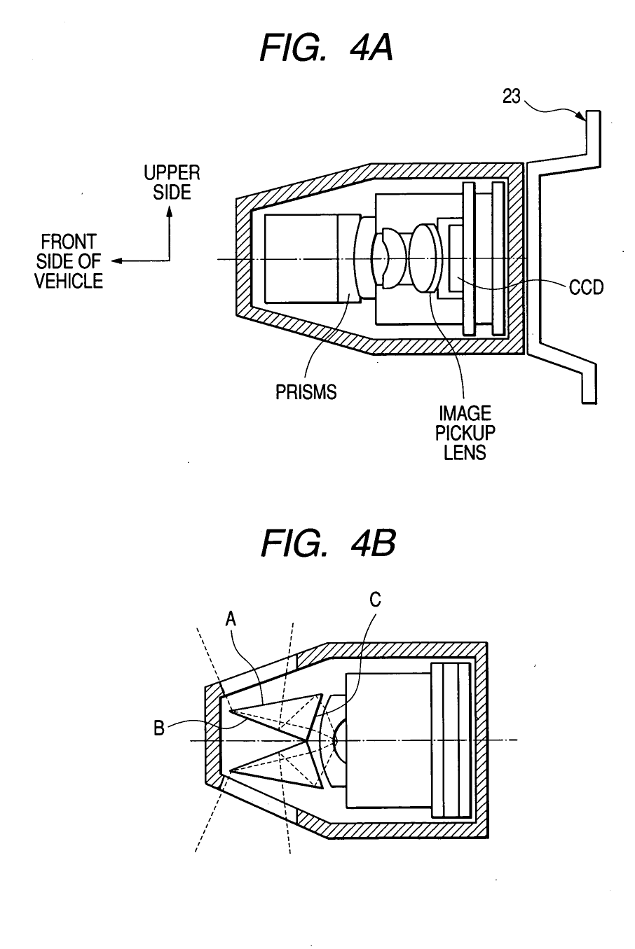

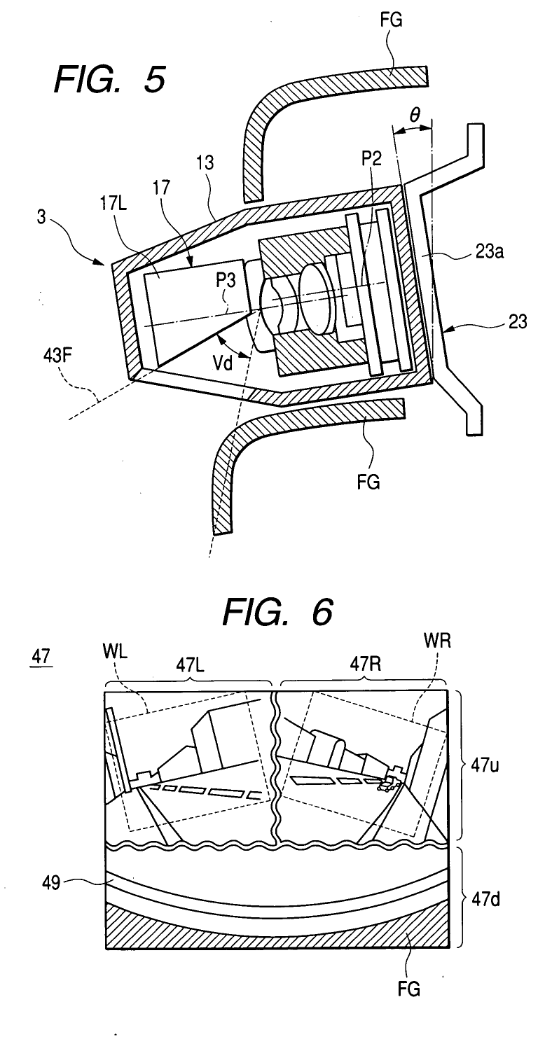

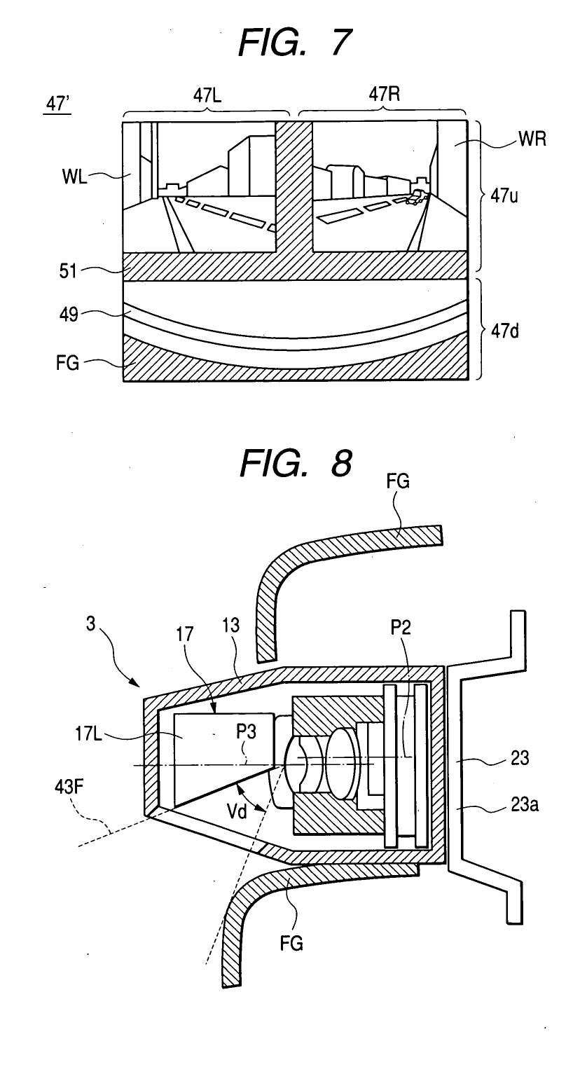

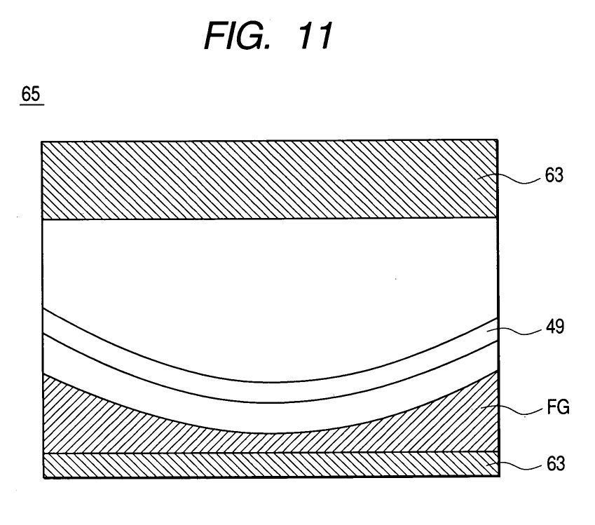

FIG. 1 is a general configuration view of an apparatus for visually confirming a vehicle periphery according to the embodiment of the invention. FIG. 2 is a general configuration view showing a camera device in FIG. 1 in its plan. FIG. 3 is a cross-sectional view taken along the line III-III in FIG. 2. FIGS. 4A and 4B are general views showing a constrcution of a two-direction camera attached to a vehicle according to the invention in its plan view and its side view. FIG. 5 is a side view showing one example of an attached state of a camera device in FIG. 1 in a vehicle. FIG. 6 is a view showing one example of a picked-up image of the camera device in FIG. 1. FIG. 7, FIG. 10 and FIG. 11 are views showing images displayed in the display unit in FIG. 1, respectively.

The apparatus 1 for visually confirming a vehicle periphery according to the present embodiment is provided, as shown in FIG. 1, with a single camera device 3 which is installed at, for example, the front part of a vehicle and simultaneously picks up scenes in a plurality of directions of the corresponding vehicle periphery (herein, three directions which are the forward diagonally downward direction of the corresponding vehicle and both forward left and right side directions thereof (directions roughly opposed to each other)), a display unit 5 which displays picked-up images of the camera device 3 installed in the above-described vehicle, and a controller unit 7 for carrying out a prescribed image process on the picked-up images of the camera device 3.

As shown in FIG. 2 and FIG. 3, the camera device 3 is composed of a camera unit 15 and a pair of left and right prisms 17 and 19, all of which are accommodated and disposed in a light-shielding case 13.

The case 13 is formed like an enclosed box. At least both the left and right sides and the lower side at the front half section of the case 13 are formed to be inclined inwardly of the case 13, and both the left and right sides and the lower side thereof are provided with transparent windows 13L, 13R and 13F, respectively. In the case 13, its transparent windows 13L, 13R and 13F and light-shielding portion (the diagonally-lined section) other than the transparent windows 13L, 13R and 13F are integrally molded with a weatherproof grade transparent resin such as a transparent polycarbonate, etc., and only the light-shielding portion is masked, and coated by a light-shielding paint, and achromatic and transparent hard coating (for example, acrylic-based UV-hardening type) is coated on the entire outer surface of the case 13 (that is, the transparent windows 13L, 13R and 13F, and the light-shielding portion). The scratch-resistant property and weatherproofing of the case 13 can be further enhanced by the hard coating. The case 13 may be composed so as to be divided into a case body and a cover portion at a prescribed part, and the connection part between the case body and the cover portion is provided with a waterproof structure (not illustrated) such as a sealing member. The waterproof property of the case 13 can be secured by the waterproof structure.

Also, the case 13 is constructed so that, as shown in FIG. 3, an attaching bracket (attaching member) 23 to attach the case 13 to a vehicle is disposed on the outer surface (herein, for example, on the rear end face of the case 13). The attaching bracket 23 has a base portion 23a on which the case 13 is disposed. Leg portions 23b extend and widen from, for example, the upper end part and the lower end part in the circumferential part of the base portion 23a toward the rear side of the base portion 23a. The tip end parts 23c of the respective leg portions 23b are bent toward the outer circumferential side of the base portion 23a (in FIG. 3, the tip end part of the upper leg portion 23b is bent toward the upper side, and the lower leg portion 23b is bent toward the lower side) and are mounted on fixing parts to the vehicle.

The attaching bracket 23 is formed so that the length of the respective leg portions 23b and the extending angle of the leg portions 23b for the base portion 23a are adjusted in compliance with the vehicle (model) in which the camera device 3 is installed, whereby the plane direction of the base portion 23a is formed so as to be kept at a prescribed angle, for example, forward from the perpendicular direction (that is, the position of the camera device 3 is inclined, for example, downward with respect to the horizontal direction). That is, since the attaching bracket 23 can be replaced in compliance with the model of the vehicle, it is possible to adjust the inclination in the position of the camera device 3.

This attaching bracket 23 may be applied to two-direction camera attached to a vehicle as shown in FIGS. 4A and 4B. It is also possible to adjust an inclination in a position of the two-direction camera since the attaching bracket can be replaced in compliance with the model of the vehicle.

The camera unit 15 is formed so as to accommodate a pickup lens 29 and a single pickup element 31 in a holder 27. In the drawing, reference number 33 denotes an electronic circuit such as a drive circuit of the pickup element 31.

Herein, the pickup lens 29 is composed as, for example, a complex lens, and the horizontal angle thereof is set to, for example, 80° while the vertical angle is set to, for example, 60°. The pickup lens 29 is disposed so that roughly the transparent window 13F of the case 13 is contained in roughly the lower half area Vd of the vertical angle. The pickup element 31 is disposed rearward of the pickup lens 29 in a state where the vertical center axis P2 of the pickup plane 31a is shifted upward by only a prescribed dimension (for example, 0.6 mm) from the lens center axis (optical axis) P3 of the pickup lens 29 and is made parallel to the lens center axis P3 (that is, in a state where the pickup plane 31a is shifted upward of the pickup lens 29 with the pickup plane 31a made parallel to the lens plane direction of the pickup lens 29). Based on the disposing condition, as described later, light 43F (that is, light from the front pickup field range) from the transparent window 13F of the case 13 can be imaged on the upper half area of the pickup plane 31a of the pickup element 31 without the light bulging out of the pickup plane 31a of the pickup element 31.

As shown in FIG. 2 and FIG. 3, a pair of left and right prisms 17 and 19 are formed to be like a triangle column so that the prisms are made mirror-symmetrical. The pair of left and right prisms 17 and 19 are disposed in front of the pickup lens 29 in a state where these prism column axes P1 are made, for example, orthogonal to the lens center axis P3 of the pickup lens 29, and are, respectively, disposed to be face-symmetrical (that is, left/right symmetrical) on the left and right two-equal division planes S1 of the pickup lens 29. In the disposed state, the left (right) prism 17(19) has its top angle a turned forward, and the left (right) prism side 17L (19R) is faced to the left (right) transparent window 13L (13R) of the case 13. Further, the rear side 17B(19B) of the prism is faced to the pickup lens 29. The pair of left and right prisms 17 and 19 are formed by cutting off the part bulging into approximately the lower half area Vd of the vertical angle of the pickup lens 29 so that the prisms 17 and 19 are disposed in approximately the upper half area (no reference number provided) of the vertical angle area of the pickup lens 29.

And, in the left (right) prism 17 (19), while the left (right) prism side 17L (19R) and the prism rear side 17B (19B) are kept as transmission planes, a metallic layer 39 such as aluminum is deposited on the right (left) prism side 17R (19L) so that the inner plane thereof is made into a reflection plane (mirror surface), and a protective film (not illustrated) is formed by using a black paint so as to cover up the deposited plane.

With the camera device 3, scenes in the three directions including both forward left and right side directions and forward diagonally downward direction of the camera device 3 can be simultaneously picked up on the basis of the following principle.

That is, light 43F from the front side pickup field range (that is, the forward diagonally downward direction) of the case 13 is transmitted, as shown in FIG. 3, through the transparent window 13F of the case 13, is directly condensed by the pickup lens 29 without being transmitted through the prisms 17 and 19, and is imaged as an inverted image in the upper half area 31u of the pickup plane 31a of the pickup element 31, whereby the forward diagonally downward scene is picked up by the pickup element 31. Simultaneously therewith, light 43L (43R) from the left (right) side pickup field range (that is, the forward left (right) side direction) of the case 13 is transmitted, as shown in FIG. 2, through the transparent window 13L(13R) of the case 13, is made incident into the left (right) prism side 17L (19R) in the left (right) prism 17 (19), is internally reflected by the right (left) prism side 19R (17L) in the left (right) prism 17 (19), and next is internally reflected by the left (right) prism side 17L (19R). That is, the light is mirror-reversed two times in all. After the light is emerged from the rear side 17B (19B) of the prism, it is condensed by the pickup lens 29 and is imaged as an inverted image in the right (left) half area 31R (31L) of the lower half area 31d of the pickup plane 31a of the pickup element 31 (as in the light 43 from the front side pickup field range of the case 13). Therefore, the scenes in both the left and right side directions can be picked up by the pickup element 31. As described above, the scenes in the three directions including both the left and right side directions and the forward diagonally downward direction of the camera device 3 can be simultaneously picked up by a single pickup element 31. And, the picked-up image is outputted to the controller unit 7 with the entire area collectively inverted.

Also, since, in the camera device 3, the picked-up image 47 is collectively inverted (that is, without being partially inverted), for example, as shown in FIG. 6, an image picked up in the forward left side direction is taken in as an erect image in the left half area 47L in the upper half area 47u of the picked-up image 47, an image picked up in the forward right side direction is taken in as an erect image in the right half area 47R in the upper half area 47u of the picked-up image 47, and an image picked up in the forward diagonally downward direction is taken in as an erect image in the lower half area 47d of the picked-up image 47.

The camera device 3 is attached to the front part of a vehicle (herein, for example, the middle of the front grille), in a state where the position thereof is inclined by an appropriate angle with respect to the horizontal direction, for example, inclined downward, so that a part (herein, for example, the front grille) of the vehicle is taken in an image (herein, for example, only in the image picked up in the forward diagonally downward direction) at least in one picking-up direction of the images picked up in the respective picking-up directions, which are both the left and right side directions and the forward diagonally downward direction.

In further detail, as shown in FIG. 5, the camera device 3 is attached to a vehicle by the attaching bracket 23 provided in the case 13 in a state (1) where the front half portion of the case 13 protrudes forward through clearance of the front grille FG, and the rear half portion of the case 13 is accommodated and disposed rearward of the front grille FG, and in a state (2) where the position of the camera device 3 is inclined downward by an appropriate angle with respect to the horizontal direction (that is, the plane direction of the base portion 23a of the attaching bracket 23 provided in the case 13 is inclined forward by an appropriate angle from the perpendicular direction. Also, by the above-described attaching condition (2), the left (right) side pickup field range of the camera device 3 (that is, the left (right) prism side 17L (19R) is inclined rightward (leftward) by an angle around the picking-up direction.

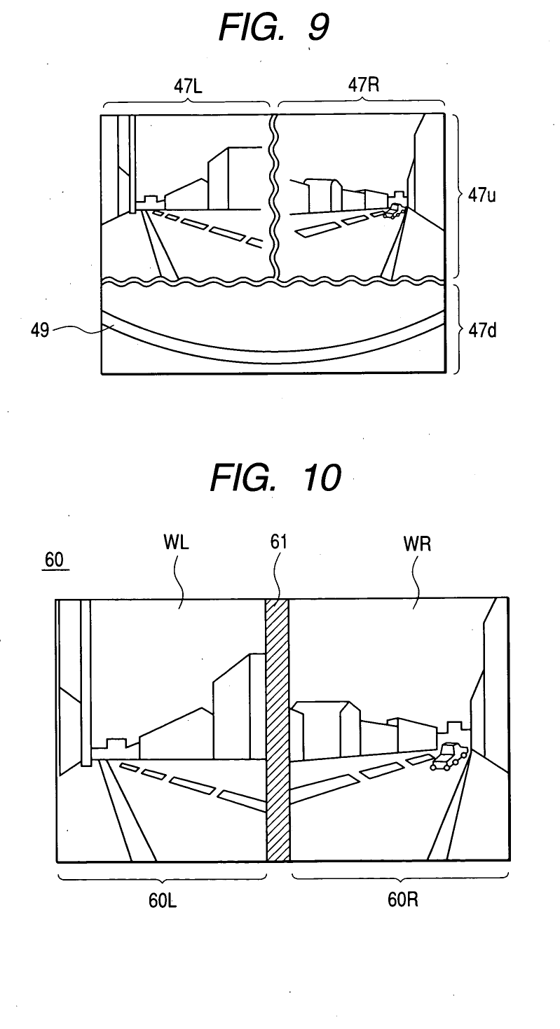

In a state where the camera device 3 is thus attached to a vehicle, the images 47 picked up by the camera device 3 (collectively inverted picked-up images) are such that, as shown in FIG. 6, the scene in the forward diagonally downward direction is not inclined and taken in the lower half area 47d so that the front grille FG is taken in the lower circumferential edge area thereof, the scene in the forward left side direction is inclined to the upper left side of the picked-up image 47 by only the degree of inclination of the left side pick-up field range of the above-described camera device 3 and is taken in the left half area 47L in the upper half area 47u, and the scene in the forward right side direction is inclined to the upper right side of the picked-up image 47 by only the degree of inclination of the right side pick-up field range of the above-described camera device 3 and is taken in the right half area 47R in the upper half area 47u. In addition, in FIG. 5, reference number 49 in 47 of FIG. 6 denotes a white line on a road. Further, as shown in FIG. 8, where the camera device 3 is attached to a vehicle in a horizontal position without being inclined downward (that is, where the plane direction of the base portion 23a of the attaching bracket 23 is made perpendicular), both the left and right pickup field ranges of the camera device 3 (that is, the left (right) prism side 17L (19R)) are not inclined in the picking-up direction. Therefore, as shown in FIG. 9, the scenes which are displayed on the image portions picked up in the forward left and right side directions on the picked-up image 47 are displayed without inclination.

The controller unit 7 is provided with an image processing portion 7a for carrying out a prescribed image process with respect to images 47 picked up by the camera device 3 and a changeover controlling portion 7b (display selecting device) for controlling changeover of display of the picked-up images 47, which are processed by the image processing portion 7a, onto the display unit 5.

The image processing portion 7a carries out various processes with respect to images 47 picked up by the camera device 3, which are (1) correction of inclination of the scenes taken in the pickup image portions in the respective picking-up directions (forward left and right side directions and forward diagonally downward direction) on the picked-up images 47, (2) execution of an interpolation process, (3) enlargement of the picked-up image portions in the respective picking-up directions on the picked-up images 47, and (4) combination of masking image, and finishing the same to be picked-up images 47′ for display shown in FIG. 7.

In further detail, the image processing portion 7a carries out, as the above-described process (1), a rotation process with respect to an image in which the scene, taken in the picked-up image portion (picked-up image) is inclined to be displayed due to the inclination of the position of the camera device 3, of the picked-up image portion in the respective picking-up directions on the picked-up image 47 in connection with the images 47 picked up by the camera device 3, so that the inclination of the scene can be negated. That is, here, the image processing portion 7a does not carry out any rotation process with respect to the picked-up image portion in the forward diagonally downward direction of the images 47 picked up by the camera 3, but extracts a prescribed range WL (WR) (Refer to FIG. 6) of the picked-up image portion with respect to the picked-up image portion in the forward left (right) side direction and carries out a rotation process by the above-described angle in the upper rightward (leftward) direction of the picked-up image 47. Then, the image processing portion 7a further corrects the scene taken in the picked-up image portion to the perpendicular direction (See FIG. 7). Thereby, the image 47 picked up by the camera device 3 is corrected to an image in which the scenes taken in the picked-up image portion in all the picking-up directions on the picked-up image 47 are free from any inclination (that is, inclination resulting from the above-described inclination in the position of the camera device 3). Also, such an image rotation process can be achieved by, for example, setting a conversion table, showing to which pixels of the picked-up image 47 from the camera device 3 respective pixels of a display image correspond, in a memory of the image processing portion 7a in advance, and converting the coordinates in compliance with the conversion table during real time.

Further, as the above-described process (2) (interpolation process), the image processing portion 7a carries out, for example, a publicly known bilinear method or bicubic method, etc., with respect to the images 47 picked up by the camera device 3, whereby it is possible to improve the quality of the picked-up images 47.

As the above-described process (3) (enlargement process), herein, the image processing portion 7a does not enlarge the picked-up image portion in the forward diagonally downward direction on the picked-up image 47 but enlarges only a prescribed range WL and WR of the picked-up image portion in the forward left and right side directions on the picked-up image 47 at a prescribed enlargement ratio.

In addition, as the above-described (4) process (combination of masking images), as shown in, for example, FIG. 7 herein, the image processing portion 7a overlaps an inverted T-shaped masking image 51 with respect to the picked-up image 47 to which the above-described processes (1) through (3) are applied, so as to cover up the boundary portion between the upper half area 47u and the lower half area 47d of the picked-up image 47 and the boundary portion between the left half area 47L and the right half area 47R in the upper half area 47u of the picked-up image 47, whereby the picked-up image portion in the forward left side direction on the picked-up image 47, the picked-up image portion in the forward right side direction, and the picked-up image portion in the forward diagonally downward direction are sectioned by the masking image 51, and the picked-up image portions in all the picking-up directions can be easily identified.

In addition, the extraction range WL and WR on the above-described picked-up image 47, rotation angle, enlargement ratio and shape of the masking image 51 are established in advance by the image processing portion 7a in compliance with vehicle models, and it is possible to change the same in compliance with the model of a vehicle in which the corresponding apparatus 1 for visually confirming a vehicle periphery is installed.

Further, the image processing portion 7a selectively displays either one of a picked-up image 47, for display, which is prepared by the image processing portion 7a and a television image or navigation image, which is described later, in the display unit 5 on the basis of control of the changeover controlling portion 7b.

Also, the image processing portion 7a selectively displays a picked-up image, at least in one direction, of the picked-up images in the respective picking-up directions in the display unit 5 on the basis of control of the changeover controlling portion 7b. For example, where only the images picked up in two directions, which are both the forward left and right side directions are displayed in the display unit 5, the image processing portion 7a modifies the inclination of the scenes taken in the picked-up image portion WL in the forward left side direction on the picked-up image 47 and the picked-up image portion WR in the forward right side direction thereon by a process similar to the above-described process (1), carries out an interpolation process by a process similar to the above-described process (2), enlarges the images at a prescribed enlargement ratio (herein, for example, in the longitudinal direction), and combines the images so that the picked-up image portion WL in the forward left side direction and the picked-up image portion WR in the forward right side direction are, respectively, disposed at the left half area 60L and right half area 60R of the picked-up images 60 for display. Simultaneously, the image processing portion 7a combines a masking image 61 at the boundary portion between the respective picked-up image portions WL and WR, finishes the same to be picked-up images 60 for display and displays the same in the display unit 5. Also, for example, where only the picked-up image in the forward diagonally downward direction is displayed in the display unit 5, the image processing portion 7a carries out an interpolation process on the picked-up image portion 47d in the forward diagonally downward direction on the picked-up image 47 by a process similar to the above-described process (2), enlarges the same at a prescribed enlargement ratio (herein, for example, in the longitudinal direction), combines a masking image 63 at a black area at the upper and lower sides of the picked-up image 65 for display, finishes the same to be the picked-up image 65 for display shown in FIG. 11, and displays it in the display unit 5.

The changeover controlling portion 7b controls the image processing portion 7a manually based on an operation signal from an operation switch or automatically based on vehicle information such as a vehicle speed sensor, a shift signal and an ignition switch signal (IG, SW signals), etc., and selectively displays either one of the respective picked-up images 47′, 60 and 65 for display, which are prepared by the image processing portion 7a, television images received by a television tuner 55, or a navigation image acquired from a car navigation unit 57 in the display unit 5.

According to the apparatus 1 for visually confirming a vehicle periphery, which is constructed as described above, since the camera device 3 is installed in a vehicle with the position thereof inclined so that a part of the vehicle (here, the front grille FG) is taken in a picked-up image portion (here, the picked-up image portion in the forward diagonally downward direction) at least in one picking-up direction of the picked-up image portion (picked-up images) in the respective picking-up directions of the picked-up images 47, it becomes easier to sensorially understand, on the basis of reference to a part of the vehicle, which is taken in the picked-up image portion, in which direction of the vehicle the picked-up image displayed in the display unit 5 is taken, and further it becomes easier to understand the distance between an obstacle taken in the picked-up image 47, and the vehicle. Herein, the camera device 3 is installed in a vehicle with the position thereof inclined so that it can simultaneously pick up the scenes in the three directions including both the forward left and right side directions and the forward diagonally downward direction of the vehicle and a part of the vehicle is taken in the picked-up image in the forward diagonally downward direction, and since the display unit 5 simultaneously displays the picked-up images in the three directions including both the forward left and right side directions and the forward diagonally downward direction, it becomes easier to sensorially understand, on the basis of reference to a part of the vehicle taken in the picked-up image portion in the forward diagonally downward direction, that the picked-up images 47′ displayed in the display unit 5 are the scenes in the three directions including both the forward left and right side directions and the forward diagonally downward direction, and at the same time, it becomes easier to understand the distance between an obstacle taken in the picked-up image 47′ and the vehicle.

Furthermore, since the apparatus 1 is provided with an image processing portion 7a, and the picked-up images in the respective picking-up directions (herein, the picked-up images in both the forward left and right side directions) are rotated by the image processing portion 7a, it is possible to negate the inclination of the scenes taken in the picked-up images in the picking-up direction, which results from the inclination in the position of the camera device 3, and it is not necessary that the camera device 3 is produced with the disposing angles of the components (optical system and pickup elements) differing per vehicle model, wherein the camera device 3 can be commonly used, thereby further improving the visibility of the picked-up images 47 while lowering the production costs.

In addition, since the camera device 3 is attached, with the position thereof inclined, to a vehicle by an attaching bracket 23, and the attaching bracket 23 can be replaced per vehicle model, the inclination in the position of the camera device 3 can be adjusted for respective vehicle models, wherein since it is possible to adjust the position of the camera device 3 by only replacing the attaching bracket 23, the attaching bracket 23 contributes to fostering common use of the camera device 3.

Also, since a picked-up image at least in one direction of the respective picking-up directions can be selectively displayed in the display unit 5 manually on the bas is of operations by an operation switch or automatically on the basis of vehicle information, it is possible to selectively display only a picked-up image in a prescribed picking-up direction, and to selectively display only a picked-up image in an appropriate picking-up direction in compliance with driving states, wherein the degree of freedom can be increased with respect to the composition of the image display.

Further, in the present embodiment, a description was given of a case where a camera device is installed at the front part of a vehicle and scenes in the three directions including both the forward left and right side directions and the forward diagonally downward direction of the corresponding vehicle. However, the invention is not limited to the above-described embodiment. For example, the invention may be applicable to a case where a camera device is installed at the rear part of a vehicle and scenes in the three directions including both rearward left and right side directions and the rearward diagonally downward direction.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. An apparatus for visually confirming a vehicle periphery comprising:
a camera device which is attached to a vehicle while a position of the camera device is inclined, and which picks up an image in at least one direction at the vehicle periphery; and
a display unit which is attached to the vehicle, and which displays the picked-up image in the at least one direction, wherein
an image-processing device carries out a rotation process with respect to the picked-up image, in which a scene taken in the picked-up image is inclined due to an inclination resulting from the position of the camera device, so that an inclination of the scene is negated, and which displays the scene in the display unit.

2. An apparatus for visually confirming a vehicle periphery according to claim 1, wherein
the camera device is attached to the vehicle by an attaching member in a state where the position of the camera is inclined,
an inclination of the position of the camera device is adjusted in compliance with the vehicle by replacing the attaching member in compliance with the vehicle.

3. An apparatus for visually confirming a vehicle periphery according to claim 1, further comprising:
a display-selecting device which selectively displays the picked-up image in the at least one direction on the display unit manually by a prescribed switch operation or automatically on the basis of vehicle information of the vehicle.

4. An apparatus for visually confirming a vehicle periphery according to claim 1, wherein
the camera device simultaneously picks up scenes in three directions including both forward left and right side directions and forward diagonally downward direction of the vehicle,
the camera device is attached to the vehicle in a state where the position of the camera device is inclined, so that the vehicle is at least partially taken in the picked-up image in the forward diagonally downward direction, and
the display unit simultaneously displays picked-up image in the three directions including both forward left and right side directions and forward diagonally downward direction, which are picked up by the camera device.

5. An apparatus for visually confirming a vehicle periphery comprising:
a camera device which is attached to a vehicle, and which picks up an image in at least one direction at the vehicle periphery; and
a display unit which is attached to the vehicle, and which displays the picked-up image in the at least one direction, wherein
the camera device is attached to the vehicle while a position of the camera device is inclined, so that a vehicle is at least partially taken in the picked-image in the at least one direction, and
an image-processing device carries out a rotation process with respect to the picked-up image, in which a scene taken in the picked-up image is inclined due to an inclination resulting from the position of the camera device, so that an inclination of the scene is negated, and which displays the scene in the display unit.

6. An apparatus for visually confirming a vehicle periphery according to claim 5, wherein
the camera device is attached to the vehicle by an attaching member in a state where the position of the camera is inclined,
an inclination of the position of the camera device is adjusted in compliance with the vehicle by replacing the attaching member in compliance with the vehicle.

7. An apparatus for visually confirming a vehicle periphery according to claim 5, further comprising:
a display-selecting device which selectively displays the picked-up image in the at least one direction on the display unit manually by a prescribed switch operation or automatically on the basis of vehicle information of the vehicle.

8. An apparatus for visually confirming a vehicle periphery according to claim 5, wherein
the camera device simultaneously picks up scenes in three directions including both forward left and right side directions and forward diagonally downward direction of the vehicle,
the camera device is attached to the vehicle in a state where the position of the camera device is inclined, so that the vehicle is at least partially taken in the picked-up image in the forward diagonally downward direction, and
the display unit simultaneously displays picked-up image in the three directions including both forward left and right side directions and forward diagonally downward direction, which are picked up by the camera device.
